(19) United States
(12) Patent Application Publication
(10) Pub. No.: US 2009/0037482 A1
(43) Pub. Date: Feb. 5, 2009

(54) METHOD AND APPARATUS FOR ACHIEVING CONSISTENCY OF FILES IN CONTINUOUS DATA PROTECTION

(75) Inventors: Hiroshi ARAKAWA, Sunnyvale, CA (US); Yoshiki Kano, Kanagawa (JP)

Correspondence Address: SUGHRUE MION, PLLC, 2100 Pennsylvania Avenue, N.W., Washington, DC, 20037, US

(73) Assignee: HITACHI, LTD., Tokyo (JP)

(21) Appl. No.: 11/832,587

(22) Filed: Aug. 1, 2007

(51) Int. Cl. G06F 17/30

(52) U.S. Cl. 707/200; 707/E17.001

(57) ABSTRACT

In one implementation, the system comprises host computes, a management terminal and a storage system having a journaling capability mentioned above. The storage system can make and insert markers including status information of related files in the journal. The storage system provides information regarding the markers such that the user can search a maker indicating time point that has required consistency. Then the user or application software can obtain data in the time point with whole consistency of related data. In another implementation, the storage system can make and insert markers that indicate database's commit point regarding file managed by the database. The storage system provides information regarding the makers, therefore user or application software can obtain data in the time point with whole consistency of related data by specifying a marker as time point to be recovered.

### DESCRIPTION OF THE INVENTION

1. Field of the Invention

This invention generally relates to storage technology and, more specifically, to data protection and recovery of files and data.

2. Description of the Related Art

A conventional method for performing a backup and recovery of data is to backup data periodically (e.g. once a day) from a storage system to a backup media, such as magnetic tapes. In taking the data backup, a snapshot of a storage area (e.g. a storage volume) is often used to obtain data with consistency. That is, the data is read from a snapshot or a quiescence image and wrote to the backup media. Several methods for providing a snapshot of a storage area in a storage system, using either logical or physical techniques are well known in the art. The backup data saved on the backup media is a static data and is copied to a new storage area (e.g. a new volume) when the data needs to be restored.

However, the above conventional method can only restore the image of the data at the time point of the snapshot, and restoring data from the backup data may result in a loss of certain amount of updates because the backup data may not be entirely up to date. Moreover, if the latest backup data is, for example, inconsistent or corrupt, an older generation of the backup data must be used in the restore operation.

Recently, there emerged new advanced storage systems having a capability to perform journaling and to restore data using the journal. This capability is known as a continuous data protection (CDP). With this capability, all updates for a storage area are recorded as a journal, and the data at an arbitrary time point can be restored using the journal. In this journaling and restoring operation, snapshots may used. That is, besides the journal, snapshots of the storage area are maintained at predetermined intervals, and restoring the data at an arbitrary time point is achieved by applying the journal between time point of a snapshot and the time point to the snapshot. One system and method for providing the aforesaid CDP capability is disclosed in U.S. Pat. No. 7,111,136.

In this conventional method, however, when user application software uses multiple related files (i.e. these files have some relation), the consistency of such files as a whole may not be achieved in the event one file has been closed but one or more other files have not been closed during the journaling operation. As would be appreciated by those of skill in the art, a file is in a consistent state when it is closed by application software. Therefore, methods and apparatuses for searching time points wherein all related files have been closed (i.e. each file is in consistent state) during the journaling operation are needed to achieve the consistency of a group of files as a whole.

In another related case, there may be a database (DB) application, which manages files handling relatively large volumes of data. In such a data system, the data is stored as files in the file system area and the management information (location information etc.) of the data is stored in the database. In this case, for data recovery using the journaling capability, methods and apparatuses for seeking time points wherein both of the database and the file have consistency as a whole are also needed.

Thus, the conventional technology fails to provide techniques for searching the journal for time points wherein all related files have been closed. In addition, the conventional technology fails to provide methodology for finding a time point when both a database and a related file have consistency as a whole.

### SUMMARY OF THE INVENTION

The inventive methodology is directed to methods and systems that substantially obviate one or more of the above and other problems associated with conventional techniques for backup and recovery of data.

In accordance with one aspect of the inventive concept, there is provided a computerized data storage system. The inventive system includes a production volume storing application data; a base volume storing a copy of the application data; and a journal volume storing updates to the application data stored in the production volume. The production volume, the base volume and the journal volume form a consistency group. The journal volume is additionally operable to store a marker including a status information on at least two related files stored in the data storage system.

In accordance with another aspect of the inventive concept, there is provided a computerized data storage system. The inventive system includes a production volume storing application data; a base volume storing a copy of the application data; and a journal volume storing updates to the application data stored in the production volume. The production volume, the base volume and the journal volume form a consistency group. The journal volume is also configured to store a marker including a status information on at least one file stored in the data storage system and commit status information on a database table stored in the data storage system, which is related to the at least one file.

In accordance with one aspect of the inventive concept, there is provided a method involving storing application data in a production volume of a data storage system; storing a copy of the application data in a base volume of the data storage system and storing in a journal volume of the data storage system updates to the application data stored in the production volume. The production volume, the base volume and the journal volume form a consistency group. The inventive method further involves storing in the journal volume a marker comprising a status information on at least two related files stored in the data storage system.

In accordance with one aspect of the inventive concept, there is provided a method involving storing application data in a production volume of a data storage system; storing a copy of the application data in a base volume of the data storage system and storing in a journal volume of the data storage system updates to the application data stored in the production volume. The production volume, the base volume and the journal volume form a consistency group. The inventive method further involves storing in the journal volume a marker comprising a status information on at least one file stored in the data storage system and commit status information on at least one database table stored in the data storage system, which is related to the at least one file.

In accordance with one aspect of the inventive concept, there is provided a computer-readable medium storing computer-executable instructions implementing a method involving storing application data in a production volume of a data storage system; storing a copy of the application data in a base volume of the data storage system and storing in a journal volume of the data storage system updates to the application data stored in the production volume. The production volume, the base volume and the journal volume form a consistency group. The inventive method further involves storing in the journal volume a marker comprising a status information on at least two related files stored in the data storage system.

In accordance with one aspect of the inventive concept, there is provided a computer-readable medium storing computer-executable instructions implementing a method involving storing application data in a production volume of a data storage system; storing a copy of the application data in a base volume of the data storage system and storing in a journal volume of the data storage system updates to the application data stored in the production volume. The production volume, the base volume and the journal volume forming a consistency group. The aforesaid method further involves storing in the journal volume a marker comprising a status information on at least one file stored in the data storage system and commit status information on at least one database table stored in the data storage system, which is related to the at least one file.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary system configuration of the first embodiment.

FIG. 2 illustrates an exemplary configuration of host 200 and management terminal 520.

FIG. 3 illustrates exemplary embodiment of a consistency group information table 201.

FIG. 4 illustrates exemplary embodiment of volume information 204.

FIG. 5 illustrates an exemplary method for storing journal in journal volume 630.

FIG. 6 illustrates an exemplary embodiment of contents of the metadata 634.

FIG. 7 illustrates the manner in which the host 500 accesses the files in the storage system 100.

FIG. 8 illustrates an exemplary embodiment of file group information 511.

FIG. 9 illustrates a process for creating a marker to indicate a possible recovery point.

FIG. 10 illustrates an exemplary embodiment of a process for making a marker to indicate a possible recovery point.

FIG. 11 illustrates an exemplary embodiment of a marker

FIG. 12 illustrates an exemplary embodiment of maker information.

FIG. 13 illustrates an exemplary embodiment of a process for searching and determining a marker that indicates time point to be recovered, and a process of restoring data at the time point indicated by the marker.

FIG. 14 illustrates an exemplary embodiment of a process for restoring data by using journal.

FIG. 15 illustrates the use of the recovered point in time (PiT) image of the data by the host 500.

FIG. 16 illustrates an exemplary system configuration of the second embodiment.

FIG. 17 illustrates an exemplary embodiment of a process of receiving journal in the secondary storage system 100.

FIG. 18 illustrates an exemplary system configuration of the third embodiment.

FIG. 19 illustrates an exemplary embodiment of a process of journaling and making markers of this embodiment.

FIG. 20 illustrates an exemplary system configuration of the fourth embodiment.

FIG. 21 illustrates an exemplary embodiment of a process of making a marker to indicate possible recovery point.

FIG. 22 illustrates an exemplary embodiment of a marker.

FIG. 23 illustrates an exemplary embodiment of maker information.

FIG. 24 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

This invention discloses methods to search and find recover time point with the whole consistency. In this invention, operation and process regarding makers including status of related file are provided. As other method, markers indicating a commit time point of DB and related file are also provided. Using the inventive techniques, a user, application software and management software can search a recover time point with the required consistency. They can also obtain data in the time point when the related data is also consistent.

In one embodiment, the system comprises host computes, a management terminal and a storage system having a journaling capability mentioned above. The storage system can make and insert markers including status information of related files in the journal. The storage system provides information regarding the markers so that user can search a maker indicating time point that has required consistency. Then the user or application software can obtain data in the time point with whole consistency of related data.

In another embodiment, the storage system can make and insert markers that indicate database's commit point regarding file managed by the database. The storage system provides information regarding the makers, therefore user or application software can obtain data in the time point with whole consistency of related data by specifying a marker as time point to be recovered.

### A. FIRST EMBODIMENT

### A.1. System Configuration

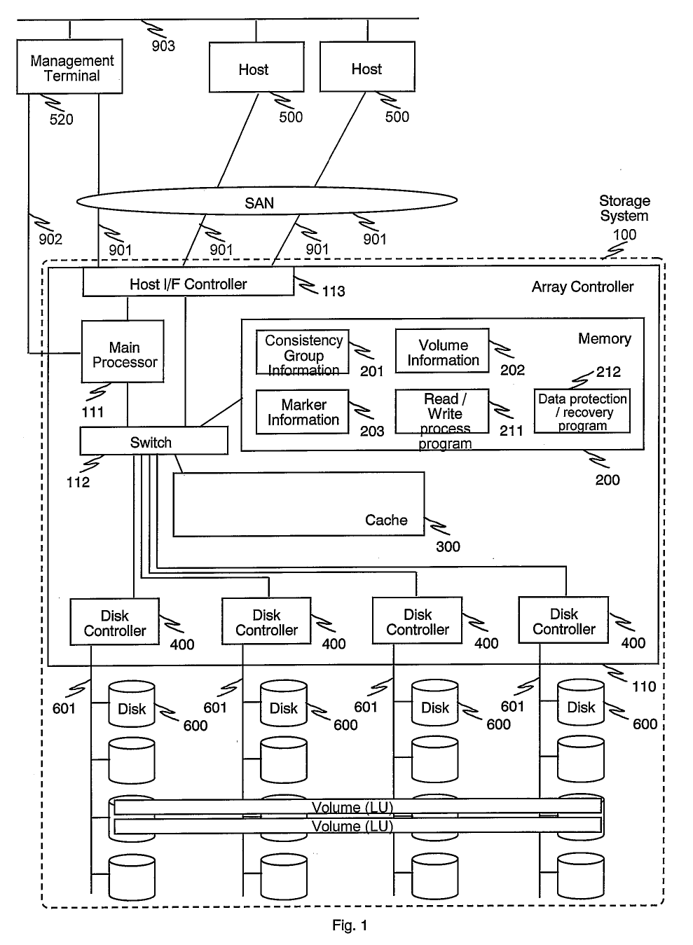

FIG. 1 describes a system configuration of the first exemplary embodiment. Specifically, an exemplary storage system implemented in accordance with the inventive techniques includes a storage system 100, array controller 110, main processor 111, switch 112, host interface 113, memory 200, cache 300, disk controller 400, disk (e.g. HDD) 600 and backend path 601 (e.g. Fibre Channel, SATA, SAS, iSCSI(IP)). The main processor 101 performs various processing tasks associated with the array controller 110. Main processor 101 and other components use various information stored in the memory 200, including, without limitation, consistency group information 201, volume information 202, marker Information 203.

The main processor 101 executes various software programs stored in the memory 200, including, without limitation, read/write process program 211 and the data protection/recovery program 212. The host 500 and the management terminal 520 are connected to the host interface 113 via the SAN 901, which may be implemented using, for example, Fibre Channel, iSCSI(IP) or any other suitable interconnect technology. The host 500 and the management terminal 520 are interconnected via LAN 903, which may be an IP-based network.

The management terminal 520 is also connected to an array controller 110 via an out-of-band network 902, which may also be an IP-based network. Various volumes (Logical Units) provided by the storage system 100 are composed from a collection of storage areas located in HDDs. Data consistency in these storage areas may be protected using a parity code, such as by utilizing the RAID configuration well known to persons of skill in the art.

### A.2. Basic Process of Journaling

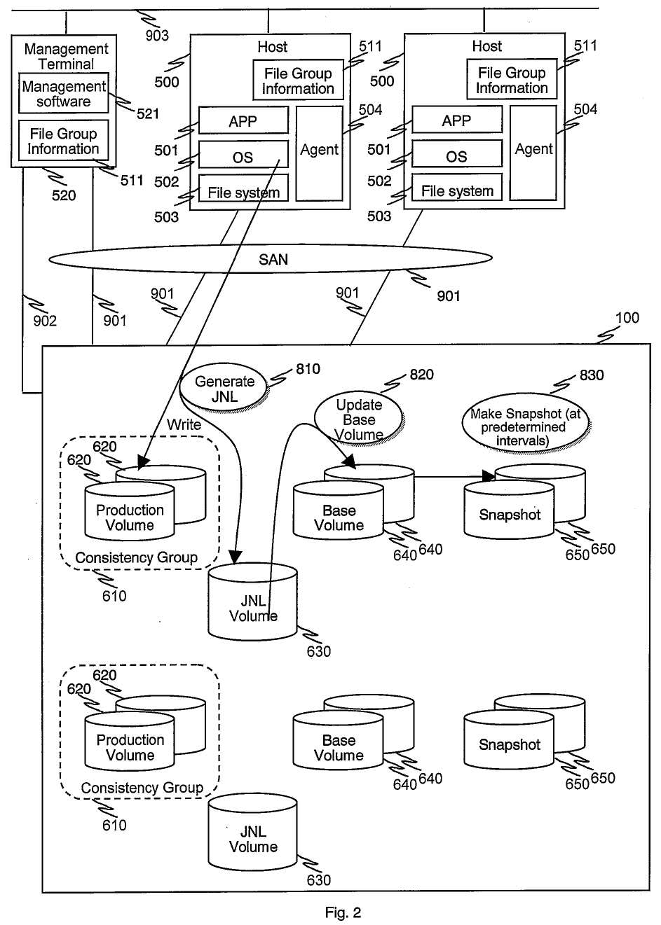

FIG. 2 illustrates a detailed exemplary configuration of the host 200 and the management terminal 520. In the described embodiment, the host 500 may be implemented as a computer platform and may have various resources (e.g. processor, memory, storage device and so on) enabling it to execute various software applications. The host 500 incorporates application software 501, OS 502, file system 503 and agent 504. The host 500 also maintains file group information 511, which includes information regarding mutually related files. An exemplary embodiment of this information will be described in detail below. The management terminal 520 may be implemented using a computer platform and may have various resources (e.g. processor, memory, storage device and the like) for performing several management tasks described in detail below. The management software 521 in the management terminal 520 enables it to perform such management tasks. The management terminal 520 also maintains file group information 511. The management terminal 520 can instruct other components of the system to set the configuration parameters of volumes (logical units) and other system resources via the SAN 901 or the network 902.

In addition, FIG. 2 also illustrates a basic process of journaling. As shown in this figure, the OS 502 stores data used by the application software 501 as files in the production volumes 620 provided by the storage system 100. The storage system 100 also has base volumes 640 that constitute a pair with the production volume 620. The base volume 640 has a mirror image data of the paired production volume 620 and receives the same data updates as the production volume 620, as will be described in detail below.

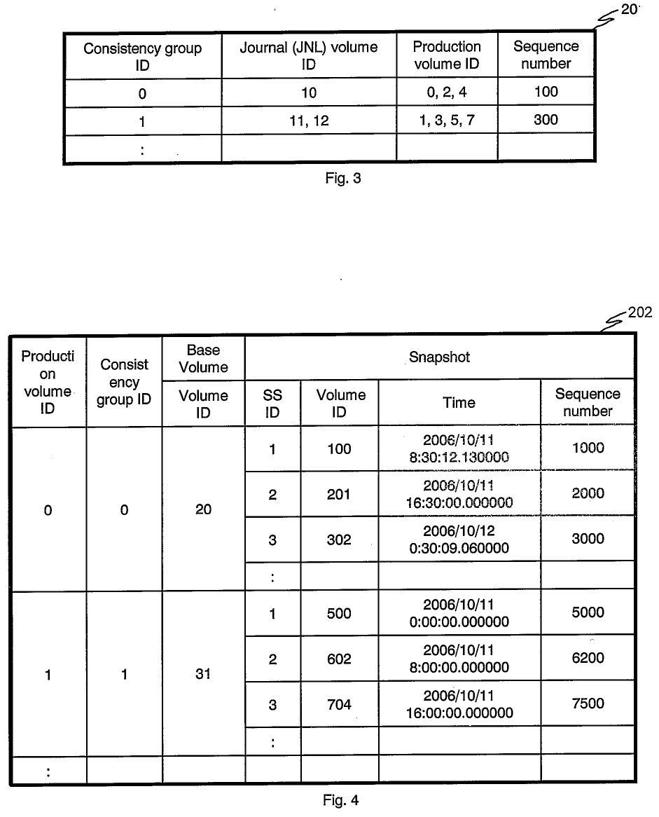

The production volumes 620 constitute a consistency group 610. The generate journal (JNL) function 810 in the storage system 100 obtains data that is transferred to update the production volumes 620, assigns a sequence number (incremental number) to the journal per each consistency group 610, and records it as journal on the journal volumes 630 that are assigned for each consistency group 610. The consistency group information 201 described in FIG. 3 includes information about each consistency group and the relation between the production volume 620 and the journal volume 630. The consistency group information 201 also records current sequence number in each consistency group 610. The volume information 202 described in FIG. 4 includes information about the relationship between the production volume 620 and the base volume 640.

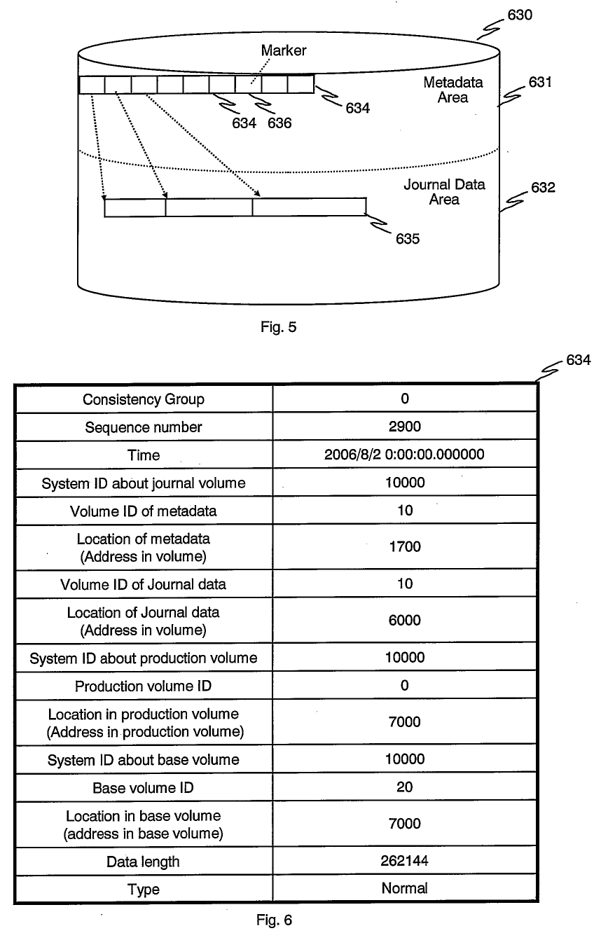

FIG. 5 illustrates an exemplary method for storing journal in the journal volume 630. The journal volume 630 is divided into two areas: metadata area 631 and the journal data area 632. The generate JNL function 810 stores update data to the journal data area 632 as the journal data 635. After that, the generate JNL function 810 generates information having a fixed length (metadata 634) for each journal, recodes the location of the journal data 635 to the metadata 634 and stores the metadata 634 in the metadata area 631. FIG. 6 illustrates an exemplary embodiment of contents of the metadata 634. For example, the metadata 634 includes the sequence number and time of the journal, in addition to information about data length, location of the journal in the journal volume 630 and the location of the corresponding data in the production volume 620.

In FIG. 2, the update base volume function 820 in the storage system 100 reads metadata, acquires journal data, and updates the base volume 640 with the journal data according to the appropriate sequence number. Moreover, the make snapshot function 830 in the storage system 100 obtains a snapshot of each base volume 640 at predetermined intervals and updates the volume information 202. As described in FIG. 4, the volume information 202 includes information about snapshots. Make snapshot function 830 records time and sequence number of journal corresponding to the snapshot in volume information 202. Time attached to the metadata 634 and recorded in the volume information 202 are attached by the storage controller 110 as received time or attached by the host 500 as write time.

### A.3. Process of Making a Marker

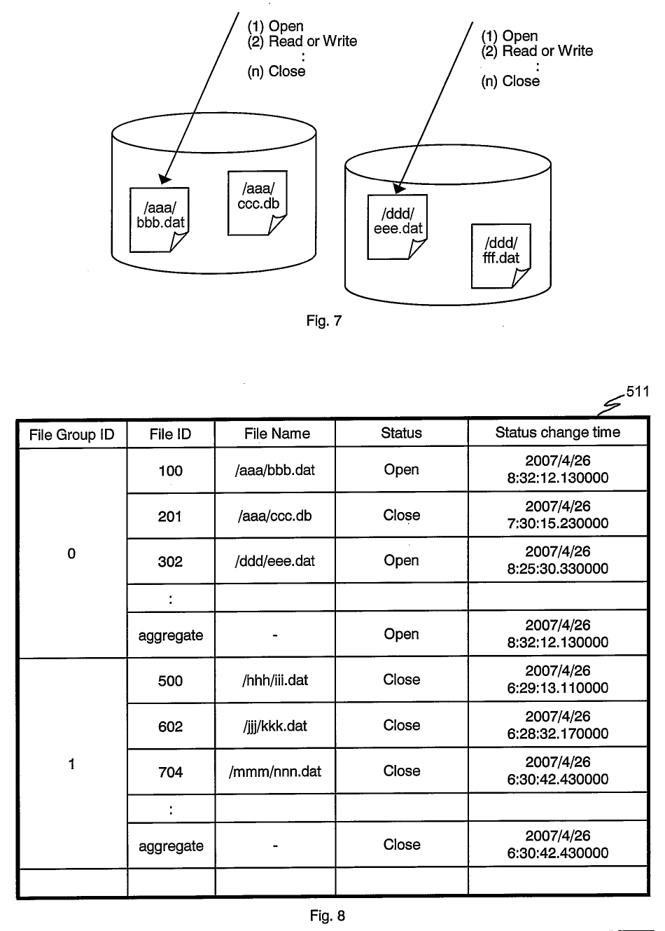

As mentioned above, the application software 501 uses the files stored in the storage system 100 and these files are related to each other from the data consistency perspective. The host 500 manages the related files and their status using the file group information 511. FIG. 7 illustrates the manner in which the host 500 accesses the files in the storage system 100. According to the request from the application software 501, the OS 502 performs read or write access to the file using the facilities provided by file systems 503. As described in FIG. 7, the file has to be opened by performing open operation before the read/write access, and the file has to be closed by performing close operation after using the file. With close operation (i.e. close status), contents (data) in the file are fixed (consistent).

FIG. 8 illustrates an exemplary embodiment of the file group information 511. A file group is a collection of files that has the mutual relation mentioned above and the file group ID is an ID for each file group. File ID is an ID assigned by the file system 503 and used to specify each file. In this example, information about a file group has one or more files (file IDs) as elements of the file group. In FIG. 8, File group information 511 also maintains file name, status and status change time. Status of ‘aggregate’ in this example means OR operated status for open status of files in the file group. That is, when one or more files are ‘open’, the aggregate status is ‘open’. On the other hand, when all files are ‘close’, the aggregate status is ‘close’. The OS 502 updates the file group information 511 with open and close operation. As other examples, the application software 511 or file system 503 may updates the file group information 511. The host 500 provides a means to define each file group and its elements described in the File group information 511.

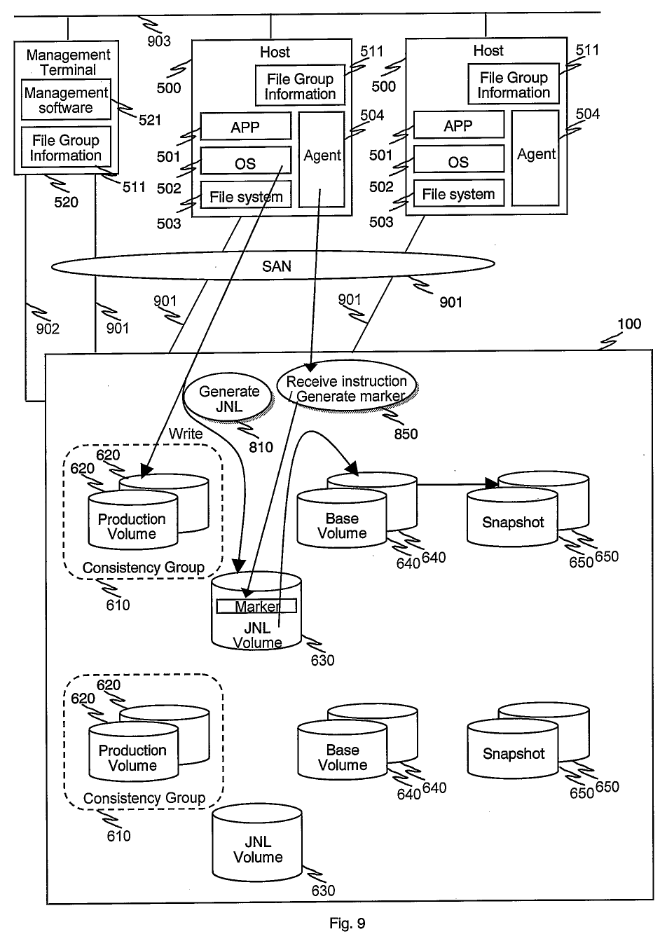

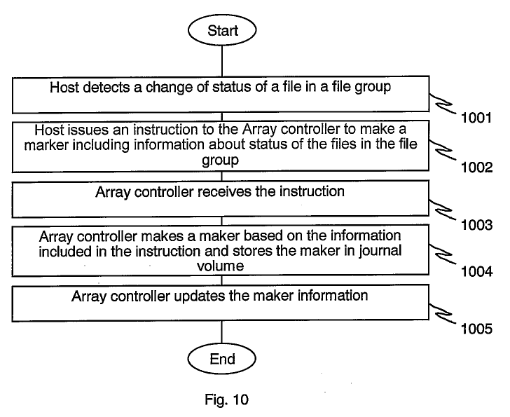

FIG. 9 and FIG. 10 illustrate a process for making a marker to indicate a possible recovery point. Specifically, at step 1001, by referring the file group information 511, the agent 504 in the host 500 detects a change of status of a file in a file group. At step 1002, the agent 504 issues an instruction to the array controller 110 to make a marker explained later. This instruction includes the identifier of the file that has the status change. The instruction also includes file group ID, status of other related files and aggregate status of the file group. The instruction also can include production volume ID of the volume that the above file resides. This instruction is transferred via SAN 901. At step 1003, the array controller 110 receives the instruction from Host 500. At step 1004, as shown in FIG. 9, the generate maker function 850 in the array controller 110 makes a special metadata of journal (i.e. marker). As shown in FIG. 5, the marker 636 is stored in Journal volume 630 as well as normal metadata. This marker maintains the information included in the instruction mentioned above.

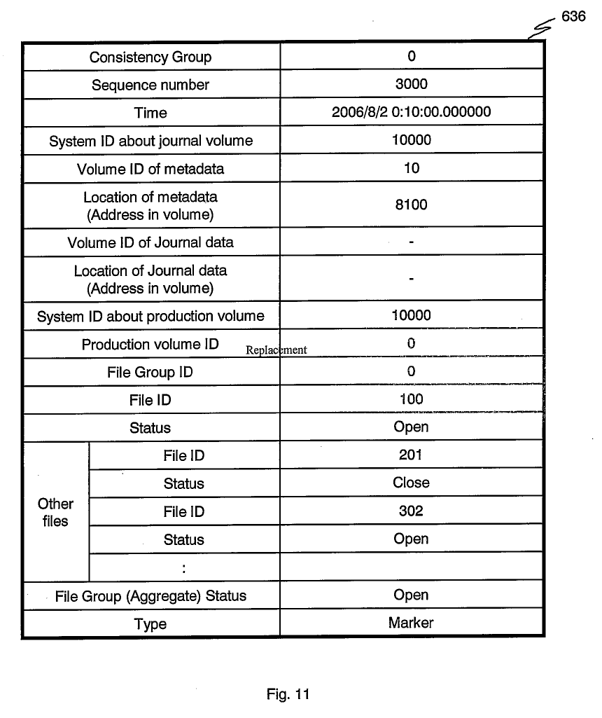

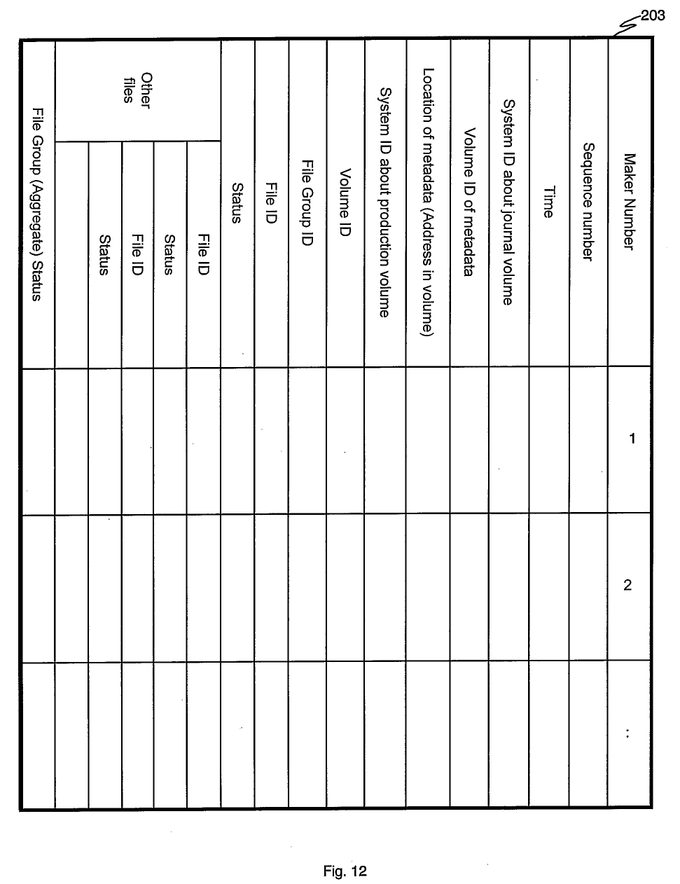

FIG. 11 describes an example of the marker. The information in the marker may be expressed by bit-coded pattern. Specifically, at step 1005, the generate maker function 850 in the array controller 110 updates the maker information 203. The maker information 203 maintains the information about each marker and the same information held by each marker. FIG. 12 shows an example of the maker information. In FIG. 12, maker number is sequential number (identifier) assigned to each marker.

### A.4. Process of Searching a Marker and Process of Restoring Data

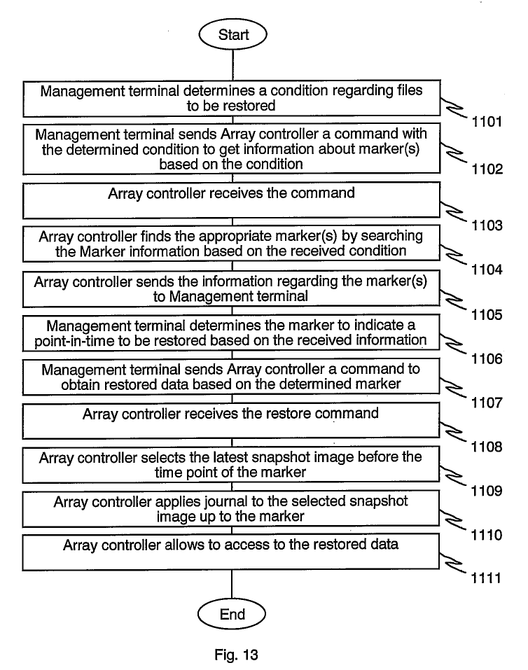

FIG. 13 describes a process of searching and determining a marker that indicates time point to be recovered, and a process of restoring data at the time point indicated by the marker. Specifically, at step 1101, the management terminal 520 determines a condition regarding files to be restored. This condition includes status (open or close) of the files in the time point to be recovered. In general, ‘close’ state of all related file is specified as the condition. This means, according to such choice, all related file must be closed in the time point. Decision regarding the recovery condition may be made by user or the management software 521 on the management terminal 520.

At step 1102, the management terminal 520 sends the Array controller 110 a command with the determined condition to get information about marker(s) based on the condition. This command is transferred via SAN 901 or out-of-band network 902. At step 1103, the array controller 110 receives the command. At step 1104, the array controller 110 finds the maker(s) that satisfy the condition by searching the Marker information 203. At step 1105, the array controller 110 sends the information regarding the appropriate maker(s) to the management terminal 520. The management terminal 520 can show the information to users. At step 1106, using the information about the selected marker(s), the management terminal 520 determines the marker to indicate a time point to be restored. This decision may be made by user or the management software 521 on the management terminal 520.

At step 1107, the management terminal 520 sends the array controller 110 a command to obtain restored data based on the determined marker. The command is transferred by SAN 901 or out-of-band network 902. At step 1108, the array controller 110 receives the restore command specifying the determined marker. At step 1109, the array controller 110 selects the latest snapshot image before the time point of the specified marker. At step 1110, the array controller 110 applies journal to the selected snapshot image up to the marker. Finally, at step 1111, the array controller 110 allows to access to the restored data.

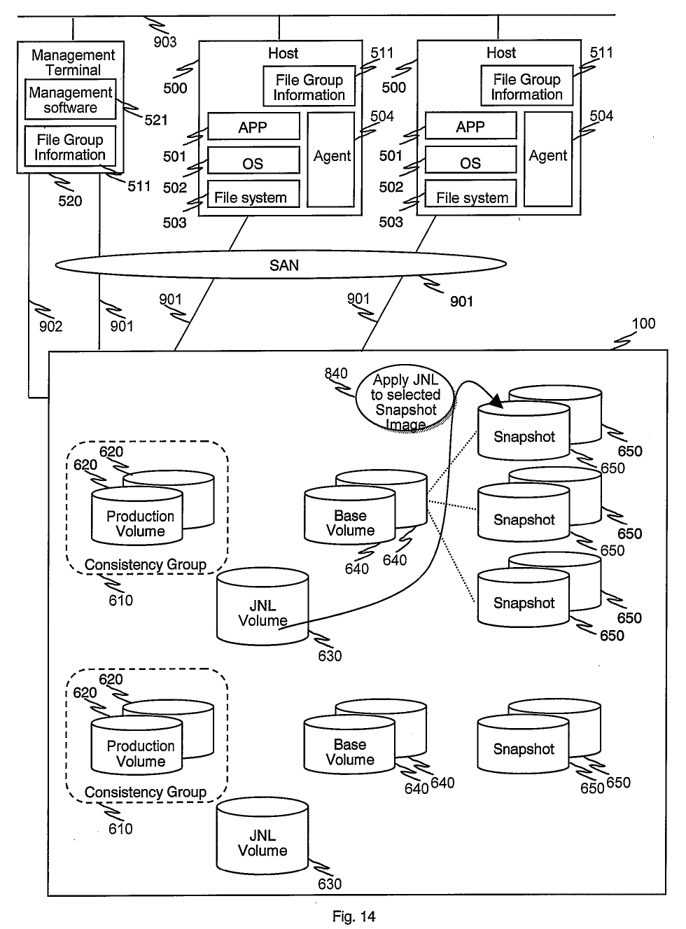

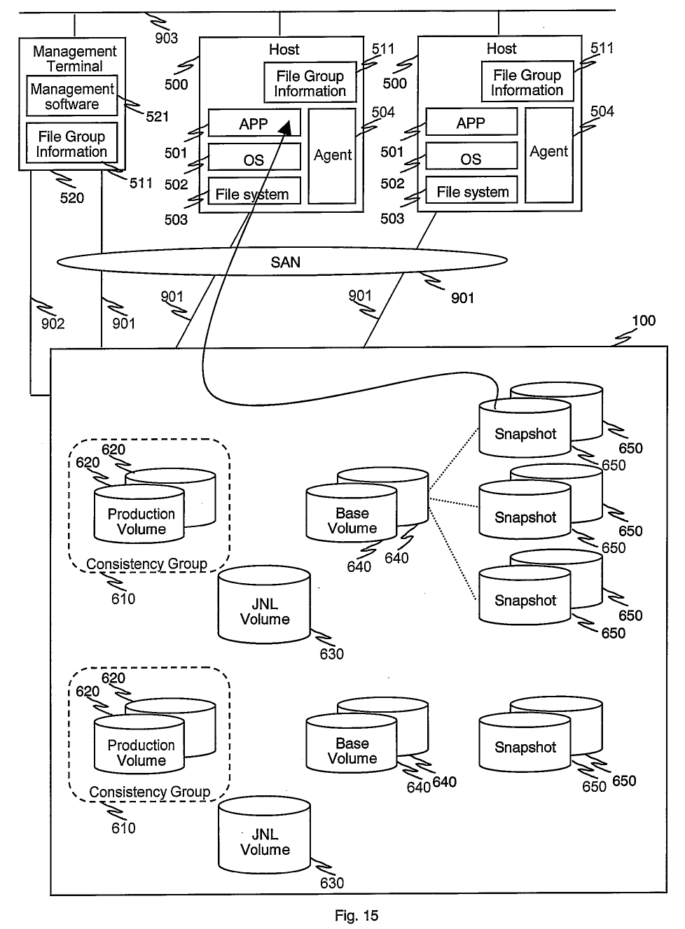

FIG. 14 also illustrates an exemplary process for restoring data using the journal. According to the restore command, apply journal function 840 selects a snapshot that has the data before the point in time to be recovered (i.e. the time point before the specified marker) (step 1109). Then, the apply journal function 840 applies (writes) journal from the journal corresponding the selected snapshot to the journal corresponding the specified point in time according to the sequence number in the Metadata 634 (step 1110). The nearest snapshot for the target point in time should be selected to make amount of journal to be applied smallest. Apply journal function 840 can recognize journal to be applied by referring Volume information 202. After completion of applying the journal, the apply journal function 840 changes status of the snapshot to accessible (read/write access is allowed) (step 1111). Then, as described in FIG. 15, the host 500 can use the recovered point in time (PiT) image of the data.

In order to determine the condition at step 1101 and determine the marker at step 1106, the management terminal 520 can have the file group information 511 and use this information for the decisions. The file group information 511 in the management terminal 520 can be generated by collecting and aggregating the file group information 511 in each Host 500 via LAN 903.

By the processes described above, the time point wherein all related files have been closed can be searched and recovered data with whole consistency regarding the related files can be obtained by users, the application software 501, OS 502, management software 521 and the like.

### B. SECOND EMBODIMENT

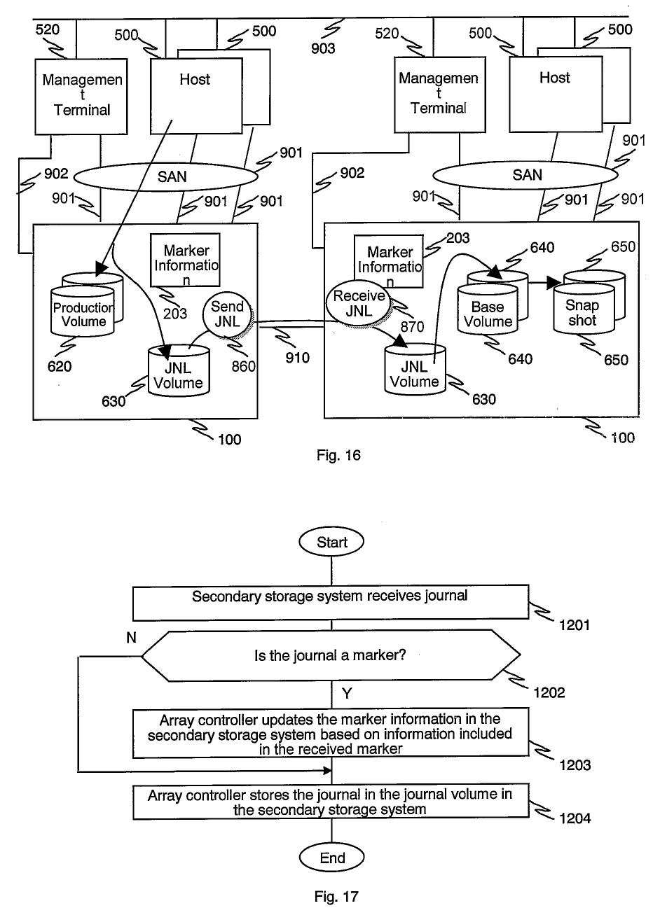

FIG. 16 describes the system configuration of the second embodiment. In the configuration of this embodiment, two storage systems 100 that have same components and configuration of the storage system 100 described in the first embodiment, the primary storage system 100 and the secondary storage system 100, are linked by data transfer path 910. As shown in the FIG. 16, journal generated and stored in the primary storage system 100 is transferred to the secondary storage system 100 by the send journal function 860, and the journal is received and stored in the journal volume 630 in the secondary storage system 100. In other words, the first part of the basic process of journaling described in the first embodiment is performed in the primary storage system, and the other part is performed in the secondary storage system 100. The journal includes markers mentioned in the first embodiment.

In the secondary storage system 100, the receive journal function 870 receives journals sent from the primary storage system 100. When the receive journal function 870 receives (detects) a marker, the receive journal function 870 records the information about the marker in marker information 203 in the secondary storage system 100. That is, the marker information 203 is regenerated in the secondary storage system 100.

FIG. 17 describes an exemplary process for receiving journal in the secondary storage system 100. Specifically, at step 1201, the array controller 110 of the secondary storage system 100 receives the journal sent from the primary Storage system 100. At step 1202, the array controller 110 checks type of the received journal. If the journal is a marker, the process proceeds to step 1203. If not, the process proceeds to step 1204. At step 1203, the array controller 110 in the secondary storage system 100 updates the marker information 203 according to the information included in the received marker. At step 1204, the array controller 110 stores the journal in journal volume 630 in the secondary storage system 100.

By performing the same operations explained in the first embodiment, the time point wherein all related files have been closed can be searched and recovered data with whole consistency regarding the related files can be obtained by users, application software 501, OS 502, the management software 521 etc, with the second storage system 100, because the secondary storage system 100 can have various information mentioned in the first embodiment.

### C. THIRD EMBODIMENT

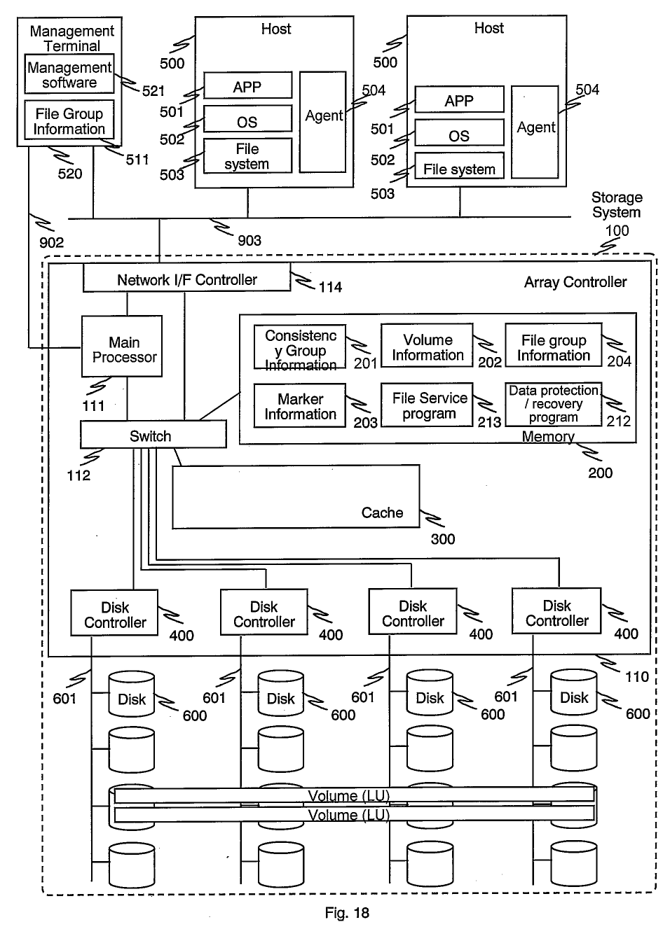

FIG. 18 describes an exemplary system configuration of the third exemplary embodiment. In the configuration of this embodiment, the array controller 110 has network interface controller 114 instead of the host interface controller 113 in the first embodiment, and the host 500 and the management terminal 520 are connected to the array controller 110 by the LAN 903 instead of the SAN 901. Moreover, the array controller 110 has a file service program 213 and provides means to handle the data stored in the storage system 100 as files. In other words, the storage system 100 has capability of the NAS (Network Attached Storage) or file server. The array controller 110 also has file group information 204 mentioned in the description of the first embodiment above. Other configuration and components are also described in the first embodiment.

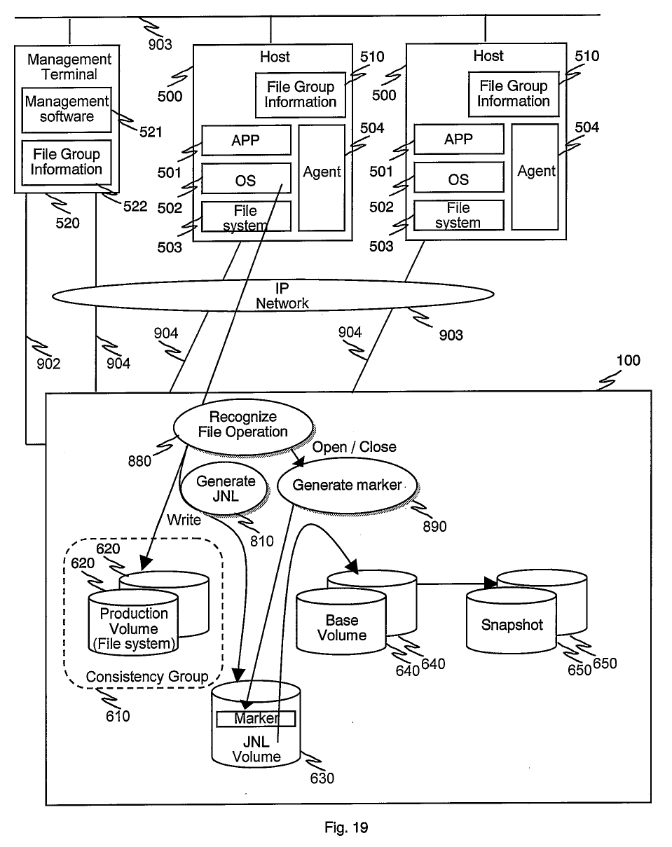

FIG. 19 illustrates a process of journaling and making markers of this embodiment. As mentioned above, the storage system 100 can recognize file operation instructed by Host 500 and the management terminal 520. Host 500 performs an open operation for a file before write operation for the file, and Host 500 also performs a close operation for the file after finishing update of the file. If the received operation is write operation, the generate file function 810 generates journal for the new or update data as well as the first embodiment. If the received operation is open or close operation for a file, generate maker function 890 generates a marker regarding the open operation or the close operation for the file. The marker includes the status of the related files and other information as well as the first embodiment. The generate marker function 890 also records the information about the marker and the related files to the marker information 203. In order to obtain the information about related files, the array controller 110 uses the file group information 204.

In addition to the above process, by performing the similar process of searching a marker and restoring data described in the first embodiment, the time point wherein all related files have been closed can be searched and recovered data with whole consistency regarding the related files can be obtained by users, application software 501, OS 502, management software 521 and so on.

### D. FOURTH EMBODIMENT

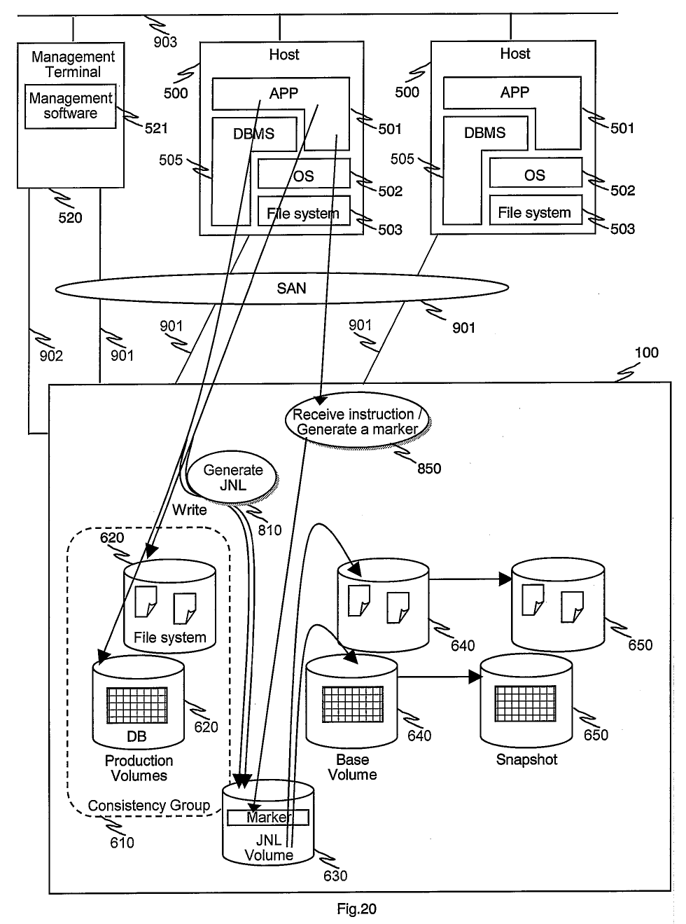

FIG. 20 illustrates the system configuration of the fourth embodiment. In the configuration of this embodiment, the host 500 has the DBMS 505. The Application software 501 uses the DBMS 505 as follows. In this embodiment, the actual data used by the application software 501 are stored as files in the storage system 100 and the management information (location information etc.) of the data are stored in database (DB) in the storage system 100, for example, in order to use large data with database. The configuration of the storage system 100 is same as the first embodiment and journal is generated by the same way mentioned in the first embodiment.

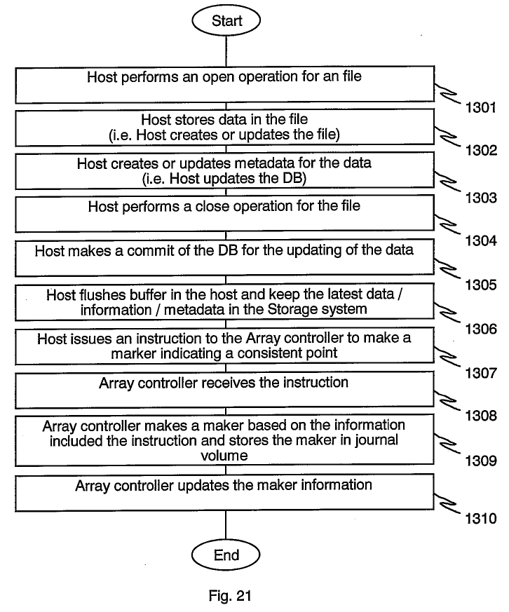

FIG. 21 describes a process of making a marker to indicate possible recovery point. Specifically, at step 1301, the host 500 performs an open operation for an file. At step 1302, the host 500 stores data in the file. That is, the host 500 creates or updates the file. At step 1303, the host 500 crates or updates the management information for the data. That is, the host updates the DB. At step 1304, the host 500 performs a close operation for the files. At step 1305, the host 500 makes a commit of the DB for the updating of the data. At step 1306, the host 500 flushes data in buffer in the host 500 to the storage system 100. This makes data and management information stored in the storage system 100 up to date. At step 1307, the host 500 issues an instruction to the array controller 110 to make a marker. This instruction is transferred via the SAN 901. At step 1308, the array controller 110 receives the instruction from Host 500. At step 1309, as shown in FIG. 20, the generate maker function 850 in the array controller 110 makes a marker.

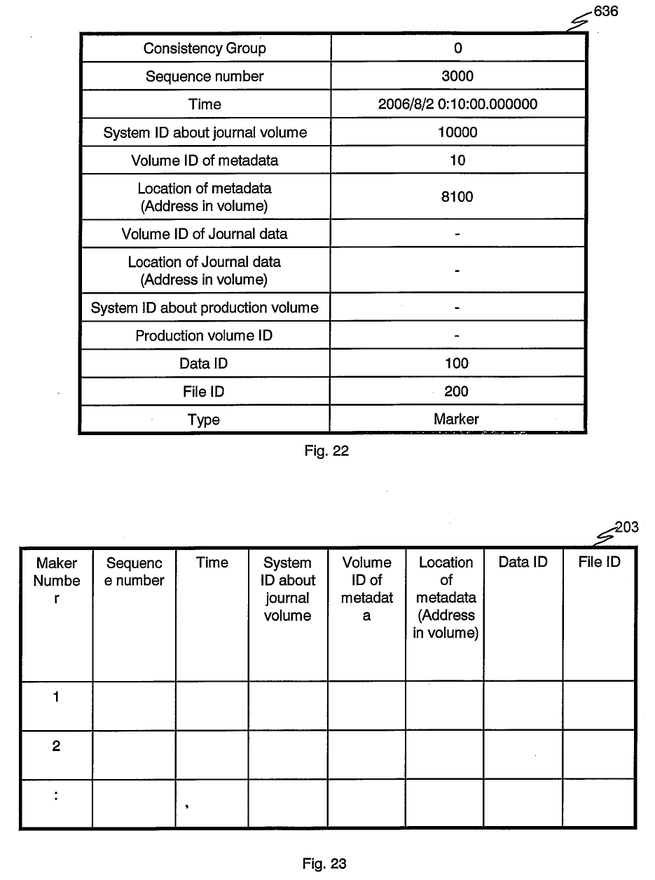

FIG. 22 describes an example of the marker. In FIG. 22, a maker has information about relation between the data and the file. Specifically, at step 1310, the generate maker function 850 in the array controller 110 updates the maker information 203 in the array controller 110. The maker information 203 maintains the information about each marker and the same information held by each marker.

FIG. 23 shows an example of the maker information. In FIG. 23, maker number is sequential number (identifier) assigned to each marker. In this embodiment, the storage system 100 performs the process of restoring data based on a specified maker as well as the first embodiment, therefore the host 500 and the management terminal 520 can obtain the consistent data in a past time point by using the maker described above. Therefore, the user or the application software 501 can obtain data in the time point with whole consistency of related data.

### E. EXEMPLARY COMPUTER PLATFORM

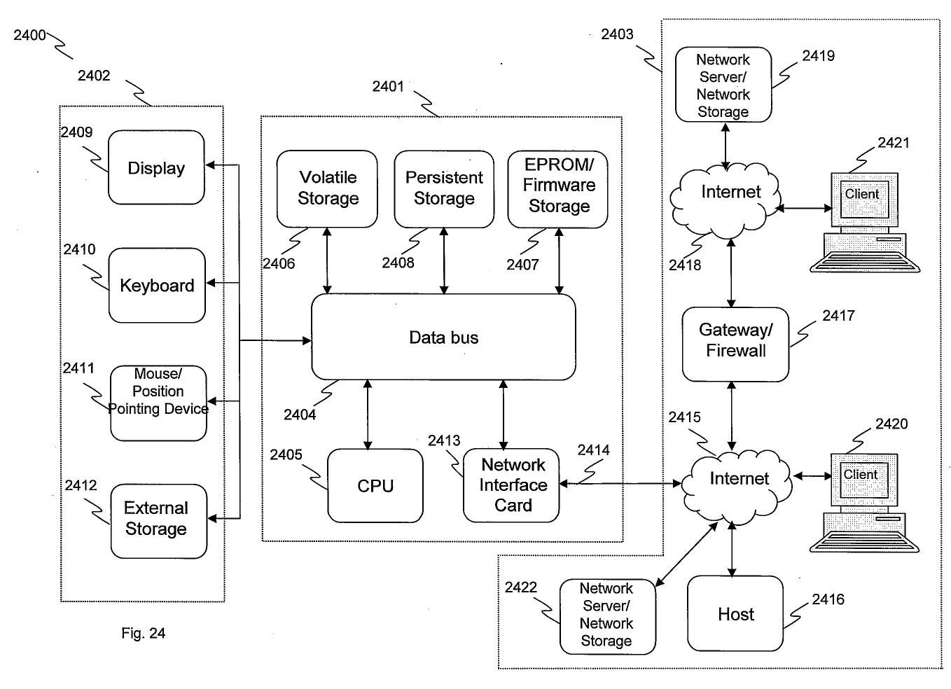

FIG. 24 is a block diagram that illustrates an embodiment of a computer/server system 2400 upon which an embodiment of the inventive methodology may be implemented. The system 2400 includes a computer/server platform 2401, peripheral devices 2402 and network resources 2403.

The computer platform 2401 may include a data bus 2404 or other communication mechanism for communicating information across and among various parts of the computer platform 2401, and a processor 2405 coupled with bus 2401 for processing information and performing other computational and control tasks. Computer platform 2401 also includes a volatile storage 2406, such as a random access memory (RAM) or other dynamic storage device, coupled to bus 2404 for storing various information as well as instructions to be executed by processor 2405. The volatile storage 2406 also may be used for storing temporary variables or other intermediate information during execution of instructions by processor 2405. Computer platform 2401 may further include a read only memory (ROM or EPROM) 2407 or other static storage device coupled to bus 2404 for storing static information and instructions for processor 2405, such as basic input-output system (BIOS), as well as various system configuration parameters. A persistent storage device 2408, such as a magnetic disk, optical disk, or solid-state flash memory device is provided and coupled to bus 2401 for storing information and instructions.

Computer platform 2401 may be coupled via bus 2404 to a display 2409, such as a cathode ray tube (CRT), plasma display, or a liquid crystal display (LCD), for displaying information to a system administrator or user of the computer platform 2401. An input device 2410, including alphanumeric and other keys, is coupled to bus 2401 for communicating information and command selections to processor 2405. Another type of user input device is cursor control device 2411, such as a mouse, a trackball, or cursor direction keys for communicating direction information and command selections to processor 2404 and for controlling cursor movement on display 2409. This input device typically has two degrees of freedom in two axes, a first axis (e.g., x) and a second axis (e.g., y), that allows the device to specify positions in a plane.

An external storage device 2412 may be connected to the computer platform 2401 via bus 2404 to provide an extra or removable storage capacity for the computer platform 2401. In an embodiment of the computer system 2400, the external removable storage device 2412 may be used to facilitate exchange of data with other computer systems.

The invention is related to the use of computer system 2400 for implementing the techniques described herein. In an embodiment, the inventive system may reside on a machine such as computer platform 2401. According to one embodiment of the invention, the techniques described herein are performed by computer system 2400 in response to processor 2405 executing one or more sequences of one or more instructions contained in the volatile memory 2406. Such instructions may be read into volatile memory 2406 from another computer-readable medium, such as persistent storage device 2408. Execution of the sequences of instructions contained in the volatile memory 2406 causes processor 2405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2405 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2408. Volatile media includes dynamic memory, such as volatile storage 2406. Transmission media includes coaxial cables, copper wire and fiber optics, including the wires that comprise data bus 2404. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2405 for execution. For example, the instructions may initially be carried on a magnetic disk from a remote computer. Alternatively, a remote computer can load the instructions into its dynamic memory and send the instructions over a telephone line using a modem. A modem local to computer system 2400 can receive the data on the telephone line and use an infra-red transmitter to convert the data to an infra-red signal. An infra-red detector can receive the data carried in the infra-red signal and appropriate circuitry can place the data on the data bus 2404. The bus 2404 carries the data to the volatile storage 2406, from which processor 2405 retrieves and executes the instructions. The instructions received by the volatile memory 2406 may optionally be stored on persistent storage device 2408 either before or after execution by processor 2405. The instructions may also be downloaded into the computer platform 2401 via Internet using a variety of network data communication protocols well known in the art.

The computer platform 2401 also includes a communication interface, such as network interface card 2413 coupled to the data bus 2404. Communication interface 2413 provides a two-way data communication coupling to a network link 2414 that is connected to a local network 2415. For example, communication interface 2413 may be an integrated services digital network (ISDN) card or a modem to provide a data communication connection to a corresponding type of telephone line. As another example, communication interface 2413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2413 sends and receives electrical, electromagnetic or optical signals that carry digital data streams representing various types of information.

Network link 2413 typically provides data communication through one or more networks to other network resources. For example, network link 2414 may provide a connection through local network 2415 to a host computer 2416, or a network storage/server 2417. Additionally or alternatively, the network link 2413 may connect through gateway/firewall 2417 to the wide-area or global network 2418, such as an Internet. Thus, the computer platform 2401 can access network resources located anywhere on the Internet 2418, such as a remote network storage/server 2419. On the other hand, the computer platform 2401 may also be accessed by clients located anywhere on the local area network 2415 and/or the Internet 2418. The network clients 2420 and 2421 may themselves be implemented based on the computer platform similar to the platform 2401.

Local network 2415 and the Internet 2418 both use electrical, electromagnetic or optical signals that carry digital data streams. The signals through the various networks and the signals on network link 2414 and through communication interface 2413, which carry the digital data to and from computer platform 2401, are exemplary forms of carrier waves transporting the information.

Computer platform 2401 can send messages and receive data, including program code, through the variety of network(s) including Internet 2418 and LAN 2415, network link 2414 and communication interface 2413. In the Internet example, when the system 2401 acts as a network server, it might transmit a requested code or data for an application program running on client(s) 2420 and/or 2421 through Internet 2418, gateway/firewall 2417, local area network 2415 and communication interface 2413. Similarly, it may receive code from other network resources.

The received code may be executed by processor 2405 as it is received, and/or stored in persistent or volatile storage devices 2408 and 2406, respectively, or other non-volatile storage for later execution. In this manner, computer system 2401 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with journaling capability. It is intended that the specification and examples be considered as exemplary only, with a true scope and spirit of the invention being indicated by the following claims.

What is claimed is:

1. A computerized data storage system comprising:
a. A production volume operable to store application data;
b. A base volume operable to store a copy of the application data; and
c. A journal volume operable to store updates to the application data stored in the production volume, the production volume, the base volume and the journal volume forming a consistency group; wherein the journal volume is also operable to store a marker comprising a status information on at least two related files stored in the data storage system.

2. The computerized data storage system of claim 1, wherein the at least two related files are used by the same software application.

3. The computerized data storage system of claim 1, wherein the status information comprises an indication of whether each of the at least two related files is open or closed.

4. The computerized data storage system of claim 1, further comprising a storage controller operable to manage the production volume, the base volume and the journal volume.

5. The computerized data storage system of claim 4, wherein the storage controller is further operable to provide information on the stored marker to a host computer such as to enable a user of the host computer to search for a time point when the at least two related files were in a consistent state.

6. The computerized data storage system of claim 5, wherein the storage controller is further operable to use the base volume and the journal volume to recover a state of the production volume at the time point when the at least two related files were in the consistent state.

7. The computerized data storage system of claim 4, wherein the storage controller is further operable to transmit the updates and the marker stored in the journal volume to a second storage system for future recovery of the state of the production volume at a time point when the at least two related files were in the consistent state.

8. The computerized data storage system of claim 4, wherein the storage controller comprises a network interface operable to connect the data storage system to a network client and wherein the storage controller is operable to execute a file service program to handle data stored in the data storage system as files.

9. A computerized data storage system comprising:
a. A production volume operable to store application data;
b. A base volume operable to store a copy of the application data; and
c. A journal volume operable to store updates to the application data stored in the production volume, the production volume, the base volume and the journal volume forming a consistency group; wherein the journal volume is also operable to store a marker comprising a status information on at least one file stored in the data storage system and commit status information on at least one database table stored in the data storage system, the at least one database table being related to the at least one file.

10. The computerized data storage system of claim 9, wherein the at least one database table is operable to store management information associated with the at least one file.

11. The computerized data storage system of claim 9, wherein the status information comprises an indication of whether the at least one file is open or closed.

12. The computerized data storage system of claim 9, further comprising a storage controller operable to manage the production volume, the base volume and the journal volume.

13. The computerized data storage system of claim 12, wherein the storage controller is further operable to provide information on the stored marker to a host computer such as to enable a user of the host computer to search for a time point when the at least one file and the at least one related database table were in a consistent state.

14. The computerized data storage system of claim 13, wherein the storage controller is further operable to use the base volume and the journal volume to recover the at least one file and the at least one related database table at the time point when the at least one file and the at least one related database table were in a consistent state.

15. The computerized data storage system of claim 12, wherein the storage controller is further operable to transmit the updates and the marker stored in the journal volume to a second storage system for future recovery of the state of the production volume at a time point when the at least one file and the at least one related database table were in a consistent state.

16. The computerized data storage system of claim 12, wherein the storage controller comprises a network interface operable to connect the data storage system to a network client and wherein the storage controller is operable to execute a file service program to handle data stored in the data storage system as files.

17. A method comprising:
a. storing application data in a production volume of a data storage system;
b. storing a copy of the application data in a base volume of the data storage system;
c. storing in a journal volume of the data storage system updates to the application data stored in the production volume, wherein the production volume, the base volume and the journal volume form a consistency group; and
d. storing in the journal volume a marker comprising a status information on at least two related files stored in the data storage system.

18. The method of claim 17, wherein the at least two related files are used by the same software application.

19. The method of claim 17, wherein the status information comprises an indication of whether each of the at least two related files is open or closed.

20. The method of claim 17, further comprising providing information on the stored marker to a host computer such as to enable a user of the host computer to search for a time point when the at least two related files were in a consistent state.

21. The method of claim 20, further comprising using the base volume and the journal volume to recover a state of the production volume at the time point when the at least two related files were in the consistent state.

22. The method of claim 17, further comprising transmitting the updates and the marker stored in the journal volume to a second storage system for future recovery of the state of the production volume at a time point when the at least two related files were in the consistent state.

23. A method comprising:
a. storing application data in a production volume of a data storage system;
b. storing a copy of the application data in a base volume of the data storage system;
c. storing in a journal volume of the data storage system updates to the application data stored in the production volume, wherein the production volume, the base volume and the journal volume form a consistency group; and
d. storing in the journal volume a marker comprising a status information on at least one file stored in the data storage system and commit status information on at least one database table stored in the data storage system, the at least one database table being related to the at least one file.

24. The method of claim 23, wherein the at least one database table stores management information associated with the at least one file.

25. The method of claim 23, wherein the status information comprises an indication of whether the at least one file is open or closed.

26. The method of claim 23, further comprising providing information on the stored marker to a host computer such as to enable a user of the host computer to search for a time point when the at least one file and the at least one related database table were in a consistent state.

27. The method of claim 26, further comprising using the base volume and the journal volume to recover the at least one file and the at least one related database table at the time point when the at least one file and the at least one related database table were in a consistent state.

28. The method of claim 23, further comprising transmitting the updates and the marker-stored in the journal volume to a second storage system for future recovery of the state of the production volume at a time point when the at least one file and the at least one related database table were in a consistent state.

29. A computer-readable medium storing computer-executable instructions implementing a method comprising:
a. storing application data in a production volume of a data storage system;
b. storing a copy of the application data in a base volume of the data storage system;
c. storing in a journal volume of the data storage system updates to the application data stored in the production volume, wherein the production volume, the base volume and the journal volume form a consistency group; and
d. storing in the journal volume a marker comprising a status information on at least two related files stored in the data storage system.

30. A computer-readable medium storing computer-executable instructions implementing a method comprising:
a. storing application data in a production volume of a data storage system;
b. storing a copy of the application data in a base volume of the data storage system;
c. storing in a journal volume of the data storage system updates to the application data stored in the production volume, wherein the production volume, the base volume and the journal volume forming a consistency group; and
d. storing in the journal volume a marker comprising a status information on at least one file stored in the data storage system and commit status information on at least one database table stored in the data storage system, the at least one database table being related to the at least one file.
